(19) United States
(12) Patent Application Publication
(10) Pub. No.: US 2005/0113558 A1
(43) Pub. Date: May 26, 2005

(54) Polyethersulfone composition, method of making and articles therefrom

(75) Inventors: Donald Scott Johnson, Scotia, NY (US); Daniel Steiger, Clifton Park, NY (US); Daniel Joseph Brunelle, Burnt Hills, NY (US); Sean Elliot Armstrong, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/719,609

(22) Filed: Nov. 20, 2003

(51) Int. Cl. C08G 75/00

(52) U.S. Cl. 528/373

(57) ABSTRACT

A polyethersulfone composition is disclosed which comprises structural units derived from a monomer mixture comprising bisphenol-A and at least 55 mole percent of 4,4′-biphenol based on total moles of diphenolic monomers, wherein the polyethersulfone has a minimum weight average molecular weight which is a function of the mole percent of structural units derived from biphenol monomer. In addition the polyethersulfones possess a notched Izod impact strength value of greater than 470 Joules per meter as measured by ASTM D256.

### BACKGROUND OF THE INVENTION

This invention relates to a polyethersulfone composition, a method to synthesize the polyethersulfone composition and articles made from the compositions.

Polyethersulfones are typically linear, amorphous, injection moldable polymers possessing a number of desirable features such as excellent high temperature resistance, good electrical properties and toughness. Due to their excellent properties, the polyethersulfones can be used to manufacture a variety of useful articles such as molded articles, films, sheets and fibers. The polyethersulfones offer high chemical and solvent resistance and are particularly useful for manufacturing articles that are exposed to solvents or chemical agents at elevated temperatures and for extended times. Thus, they find application in articles such as medical trays, which are subjected to repeated and rigorous sterilization procedures.

Many of the articles made from polyethersulfones are manufactured by injection or other molding processes. Although the currently available polyethersulfones have been very successful for the manufacture of molded articles, there is a continuing need for polyethersulfones of improved combinations of properties such as improved melt flow characteristics so that molding operations can be performed more rapidly and with improved economics. Also it is desirable that the polyethersulfone composition has good impact and heat resistance without the consequent loss of other desirable characteristics. Typically, it is difficult to obtain good flow, high impact strength and high heat resistance in a particular polyethersulfone composition.

British patent GB 1,264,900 teaches a process for production of a polyethersulfone comprising structural units derived from equimolar amounts of the reactants 4,4′-biphenol and bisphenol-A (4,4′-isopropylidenediphenol). However, the patent requires that the said reactants be present in amounts deviating from equimolar by no more than plus/minus 5 mole %.

U.S. Pat. No. 6,228,970 describes polyethersulfones comprising structural units derived from 4,4′-biphenol. However, this patent does not teach or suggest any relationship between the content of structural units derived from biphenol and the minimum molecular weight of the polyethersulfone necessary to obtain an optimum balance of physical properties. Therefore, there is a continuing need for polyethersulfones possessing a balanced property profile including high impact strength and good flow properties.

### BRIEF DESCRIPTION OF THE INVENTION

The present inventors have unexpectedly discovered that polyethersulfones with molecular weights above a certain level and comprising structural units derived from a monomer mixture comprising specific ratios of 4,4′-biphenol and bisphenol-A (BPA) monomer show excellent combinations of properties such as flow, impact strength and heat resistance. Thus, in one embodiment the present invention is a polyethersulfone composition comprising structural units derived from a monomer mixture comprising bisphenol-A and at least 55 mole percent of 4,4′-biphenol based on total moles of diphenolic monomers, wherein the polyethersulfone has a minimum weight average molecular weight (M_{w}) defined by the relationship
M_{w}=((−750)×mole percent structural units from biphenol monomer)+105,000,
and wherein said polyethersulfone has a notched Izod impact strength value of greater than 470 Joules per meter as measured by ASTM D256. Also disclosed is a synthesis method for the polyethersulfones of the present invention and articles derived from said polyethersulfones.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings. The singular forms “a”, “an” and “the” include plural referents unless the context clearly dictates otherwise. “Optional” or “optionally” means that the subsequently described event or circumstance may or may not occur, and that the description includes instances where the event occurs and instances where it does not.

Polyethersulfones of the present invention comprise structural units derived from a monomer mixture comprising bisphenol-A (BPA), 4,4′-biphenol and at least one dihalodiarylsulfone monomer. The monomer mixture comprising bisphenol-A monomer and biphenol monomer is sometimes referred to herein as a monomer mixture comprising diphenolic monomers.

Polyethersulfones of the invention comprise structural units derived from a mixture of diphenolic monomers comprising at least 55 mole percent of 4,4′-biphenol and less than or equal to 45 mole percent bisphenol-A, based on total moles of diphenolic monomers. In other embodiments the polyethersulfones comprise structural units derived from a mixture of diphenolic monomers comprising at least 58 mole percent or at least 60 mole percent of 4,4′-biphenol based on total moles of diphenolic monomers. In still other embodiments the polyethersulfones comprise structural units derived from a mixture of diphenolic monomers comprising 55-98 mole percent or 58-98 mole percent or 60-98 mole percent or 60-95 mole percent or 65-85 mole percent or 70-80 mole percent of 4,4′-biphenol based on total moles of diphenolic monomers.

In addition to structural units derived from 4,4′-biphenol and bisphenol-A monomers, polyethersulfones of the invention may optionally comprise structural units derived from 5 mole % or less of at least one additional diphenolic monomer, based on total moles of diphenolic monomers. The additional diphenolic monomer may comprise a biphenol other than 4,4′-biphenol including, but are not limited to, substituted derivatives of 4,4′-biphenol. Suitable substituents on one or both aromatic rings of additional biphenol monomers comprise halogen, bromo, chloro, fluoro, alkyl, particularly C₁-C₁₀ alkyl, allyl, alkenyl, ether, alkyl ether, cyano and the like. Additional biphenol monomers may be either symmetrical or unsymmetrical.

Additional diphenolic monomers may also comprise bisphenol monomers other than bisphenol-A. Additional bisphenol monomers comprise those represented by the formula (I): 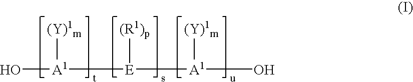
wherein A¹ represents an aromatic group including, but not limited to, phenylene, biphenylene, naphthylene, and the like. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR² wherein R² is a monovalent hydrocarbon group including, but not limited to, alkyl, aryl, aralkyl, alkaryl, or cycloalkyl; it being only necessary that Y¹ be inert to and unaffected by the reactants and reaction conditions used to prepare the polymer. In some particular embodiments Y¹ comprises a halo group or C₁-C₆ alkyl group. The letter “m” represents any integer from and including zero through the number of replaceable hydrogens on A¹ available for substitution; “p” represents an integer from and including zero through the number of replaceable hydrogens on E available for substitution; and the parameters “t”, “s” and “u” each represent an integer equal to at least one.

In bisphenol monomers of formula (I) above, when more than one Y¹ substituent is present, they may be the same or different. The same holds true for the R¹ substituent. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the aromatic residue are substituted with Y¹ and hydroxyl groups. In some particular embodiments the parameters “t”, “s”, and “u” each have the value of one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

In some embodiments of the present invention additional bisphenol monomers that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, additional bisphenol monomers comprise bis(4-hydroxyphenyl)sulfide, bis(4-hydroxyphenyl)ether, bis(4-hydroxyphenyl)sulfone, bis(4-hydroxyphenyl)sulfoxide, 4,4′-oxydiphenol, 2,2-bis(4-hydroxyphenyl)hexafluoropropane, 4,4′-(3,3,5-trimethylcyclohexylidene)diphenol; 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,2-bis(4-hydroxyphenyl)butane; 2,2-bis(4-hydroxyphenyl)-2-methylbutane; 1,1-bis(4-hydroxyphenyl)cyclohexane; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl) sulfoxide, bis(3,5-dimethyl-4-hydroxyphenyl) sulfone and bis(3,5-dimethylphenyl-4-hydroxyphenyl)sulfide.

In some embodiments of additional bisphenol monomers when E is an alkylene or alkylidene group, said group may be part of one or more fused rings attached to one or more aromatic groups bearing one hydroxy substituent. Suitable bisphenol monomers of this type include those containing indane structural units such as represented by the formula (II), which compound is 3-(4-hydroxyphenyl)-1,1,3-trimethylindan-5-ol, and by the formula (III), which compound is 1-(4-hydroxyphenyl)-1,3,3-trimethylindan-5-ol:

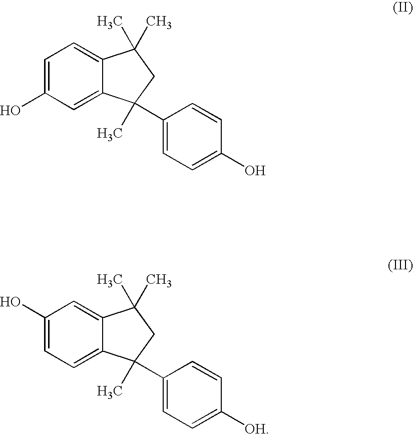

Also included among suitable additional bisphenol monomers of the type comprising one or more alkylene or alkylidene groups as part of fused rings are the 9,9-disubstituted fluorenes having formula (IV): 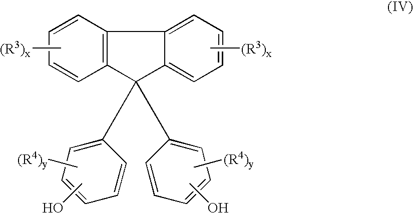
wherein each R³ and R⁴ is independently selected from monovalent alkyl, aryl and halogen radicals; and the values for the parameters x and y are each independently selected from positive integers having a value of from 0 to 3 inclusive. In some embodiments the position of each hydroxy group is para to the fluorene ring linkage, although both may be ortho or meta or one ortho or meta and the other para. In a particular embodiment the 9,9-disubstituted fluorene is 9,9-bis(4-hydroxyphenyl) fluorene.

Also included among suitable additional bisphenol monomers of the type comprising one or more alkylene or alkylidene groups as part of fused rings are the 2,2,2′,2′-tetrahydro-1,1′-spirobi[1H-indene]diols having formula (V): 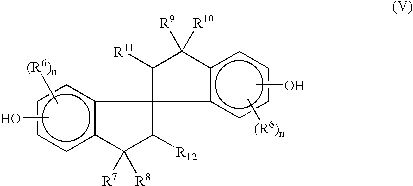
wherein each R⁶ is independently selected from monovalent alkyl, aryl and halogen radicals; each R⁷, R⁸, R⁹, and R¹⁰ is independently C₁₋₆ alkyl; each R¹¹ and R¹² is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures of any of the foregoing additional bisphenol monomers may also be employed.

In particular embodiments suitable additional bisphenol monomers include, but are not limited to, those of the formula (VI): 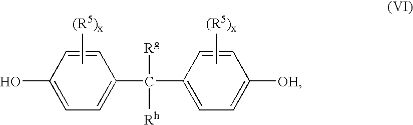
wherein each R⁵ is independently at each occurrence hydrogen, chlorine, bromine, alkyl or a C₁-C₃₀ monovalent hydrocarbon or hydrocarbonoxy group, and independently R^{g} and R^{h} are hydrogen, alkyl or a C₁-C₃₀ hydrocarbon group. The value for the parameter x is independently at each occurrence selected from positive integers having a value of from 0 to 3 inclusive.

In other particular embodiments suitable additional bisphenol monomers also include, but are not limited to, those of the formula (VII): 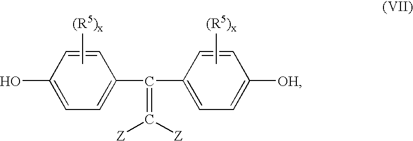
wherein each R⁵ is independently at each occurrence hydrogen, chlorine, bromine, alkyl or a C₁-C₃₀ monovalent hydrocarbon or hydrocarbonoxy group, and each Z is hydrogen, chlorine or bromine, subject to the provision that at least one Z is chlorine or bromine. The value for the parameter x is independently at each occurrence selected from positive integers having a value of from 0 to 3 inclusive. In a particular embodiment a suitable bisphenol monomer has the structure of formula (VII) wherein x is zero and Z is chlorine.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl optionally substituted with one or more groups selected from C₁-C₃₂ alkyl, C₃-C₁₅ cycloalkyl or aryl; and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl or heteroaryl radicals containing from 6 to 18 ring carbon atoms. Some illustrative non-limiting examples of these aryl radicals include C₆-C₁₅ aryl optionally substituted with one or more groups selected from C₁-C₃₂ alkyl, C₃-C₁₅ cycloalkyl or aryl. Some particular illustrative examples of aryl radicals comprise substituted or unsubstituted phenyl, biphenyl, toluyl and naphthyl. Heteroaryl groups comprise those containing from about 3 to about 10 ring carbon atoms, and include, but are not limited to, triazinyl, pyrimidinyl, pyridinyl, furanyl, thiazolinyl and quinolinyl.

The weight average molecular weights (Mw) of the polyethersulfones are dependent upon the mole percent of structural units derived from 4,4′-biphenol monomer. In one embodiment of the invention the polyethersulfones have a minimum weight average molecular weight defined by the relationship:
Mw=((−750)×mole percent structural units from biphenol monomer)+105,000.
In some particular embodiments polyethersulfones have minimum weight average molecular weights in a range of between about 30,000 and about 66,000, or in a range of between about 32,000 and about 64,000, or in a range of between about 34,000 and about 60,000. In the present context weight average molecular weights are measured by gel permeation chromatography (GPC) versus polystyrene standards.

In some particular embodiments of the invention the polyethersulfones comprise structural units derived from 4,4′-biphenol and bisphenol-A in a molar ratio of about 60:40 and have a weight average molecular weight of at least about 60,000; or comprise structural units derived from 4,4′-biphenol and bisphenol-A in a molar ratio of about 70:30 and have a weight average molecular weight of at least about 52,000; or comprise structural units derived from 4,4′-biphenol and bisphenol-A in a molar ratio of about 80:20 and have a weight average molecular weight of at least about 45,000; wherein in each embodiment said polyethersulfone has a notched Izod impact strength value of greater than 470 Joules per meter as measured by ASTM D256 and a melt viscosity of less than about 4,500 pascal-seconds as measured at 340° C. In still other particular embodiments the polyethersulfones comprise structural units derived from about 65-73 mole percent 4,4′-biphenol based on total moles of diphenolic monomers and have a weight average molecular weight in a range of about 53,000-57,000; wherein in each embodiment said polyethersulfone has a notched Izod impact strength value of greater than 700 Joules per meter as measured by ASTM D256 and a melt viscosity of less than about 4,000 pascal-seconds as measured at 340° C.

The polyethersulfones of the present invention may be made using known methods, for example, by the carbonate method or by the alkali metal hydroxide method. In a particular embodiment the polyethersulfones are made in a reaction mixture comprising alkali metal salts of the mixture comprising diphenolic monomers, at least one dihalodiarylsulfone monomer, at least one solvent and at least one phase transfer catalyst (hereinafter sometimes “PTC”). The alkali metal salts of the diphenolic monomer mixture, which are employed in the present invention, are typically sodium or potassium salts. Sodium salts are often used in particular embodiments by reason of their availability and relatively low cost. In one embodiment the salts are formed by contacting diphenolic monomers with a base, preferably an alkali metal base. In another embodiment the salts are formed by contacting diphenolic monomers with an alkali metal hydroxide.

Dihalodiarylsulfone monomers suitable for use in the invention are those which bear halogen substituents reactive to displacement by phenoxide-comprising monomers to form polyethersulfones. In particular embodiments dihalodiarylsulfones comprise at least one of dichloro- or difluorodiaryl sulfones. In other particular embodiments dihalodiarylsulfones comprise dihalodiphenylsulfones. In still other particular embodiments dihalodiarylsulfones comprise 4,4′-dihalodiarylsulfones, illustrative examples of which comprise 4,4′-dichloro- and 4,4′-difluorodiphenylsulfone.

In one embodiment the method of the invention employs at least one solvent of low polarity, usually substantially lower in polarity than that of typical dipolar aprotic solvents. In various embodiments said solvent has a boiling point above about 150° C. in order to facilitate the reaction which typically requires temperatures in the range of between about 125° C. and about 250° C. Suitable solvents of this type include, but are not limited to, ortho-dichlorobenzene, para-dichlorobenzene, dichlorotoluene, 1,2,4-trichlorobenzene, diphenyl sulfone, phenetole, anisole and veratrole, and mixtures thereof. In some embodiments said organic solvent forms an azeotrope with water. In another particular embodiment the organic solvent is ortho-dichlorobenzene.

In various embodiments suitable phase transfer catalysts are those that are substantially stable at temperatures required to effect reaction to make the polyethersulfones. Substantially stable in the present context means that the PTC is sufficiently stable to effect the desired reaction at a desired rate. Different types of catalyst may be employed for this purpose. They include quaternary phosphonium salts of the type disclosed in U.S. Pat. No. 4,273,712; N-alkyl-4-dialkylaminopyridinium salts of the type disclosed in U.S. Pat. Nos. 4,460,778 and 4,595,760; and guanidinium salts of the type disclosed in U.S. Pat. Nos. 5,081,298, 5,116,975 and 5,132,423. In some particular embodiments suitable phase transfer catalysts, by reason of their exceptional stability at high temperatures and their effectiveness to produce high molecular weight aromatic polyether polymers in high yield, comprise alpha-omega-bis(pentaalkylguanidinium)alkane salts and hexaalkylguanidinium salts including, but not limited to, hexaalkylguanidinium halides and especially hexaalkylguanidinium chlorides. Methods for employing guanidinium salts as catalysts are disclosed, for example, in U.S. Pat. No. 5,229,482. In a particular embodiment a catalyst comprising hexaethylguanidinium chloride is employed.

In one embodiment of the present invention the catalyst is present in the range of about 0.5 mole percent to about 10 mole percent based on the total amount of alkali metal salt. The total amount of salt is defined herein as the total amount of the salts of the diphenolic monomer mixture. In an alternate embodiment the catalyst is present in the range of about 1 mole percent to about 4 mole percent based on the total amount of salt. In another embodiment the catalyst is present in the range of about 2 mole percent to about 4 mole percent based on the total amount of salt.

Reaction mixtures for preparation of polyethersulfones of the invention may optionally comprise at least one chain termination agent. Suitable chain termination agents include, but are not limited to, all those with an activated substituent suitable for displacement by a phenoxide group during the polymerization process. In various embodiments suitable chain termination agents include, but are not limited to, alkyl halides such as alkyl chlorides, and aryl halides including, but not limited to, chlorides of formulas (VIII): 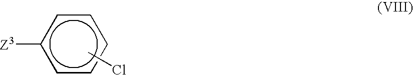
wherein the chlorine substituent is in the 3- or 4-position, and Z³ comprises a substituted or unsubstituted alkyl or aryl group. In some embodiments suitable chain termination agents of formula (VIII) comprise monochlorobenzophenone, 4-chlorobenzophenone, monochlorodiphenylsulfone, or 4-chlorodiphenylsulfone. Other suitable chain-termination agents comprise activated phthalimides, illustrative examples of which include, but are not limited to, chloro-N-arylphthalirnides, chloro-N-alkylphthalimides, 3-chloro-N-phenylphthalimide, 4-chloro-N-phenylphthalimide, 3-chloro-N-methylphthalimide or 4-chloro-N-methylphthalimide. Mixtures comprising two or more chain termination agents can also be used.

A chain termination agent may optionally be added to the reaction mixture in any convenient manner, for example to obtain a desired molecular weight. In particular embodiments at least one chain termination agent is added all at once or in portions at any time during the polymerization reaction. At least one chain termination agents may optionally be added by itself or in admixture with one or more monomers.

Reaction temperatures in embodiments of the invention are most often in the range of between about 125° C. and about 250° C. in some embodiments, and in the range of between about 180° C. and about 225° C. in other embodiments. In an alternate embodiment the reaction temperature is most often in the range of between about 150° C. and about 180° C. In yet another embodiment the reaction temperature is at least about 150° C.

In one embodiment, the reagents employed, which comprise alkali metal salts of diphenolic monomer mixture, dihalodiaryl sulfone and solvent, are substantially dry. In the present context substantially dry means that the reaction mixture comprising the said reactants contains at most about 100 ppm by weight of water. In some particular embodiments the amount of water in the reaction mixture is less than about 50 ppm, and in still other embodiments less than about 20 ppm. The proportion of water may be determined by any convenient means and is typically determined by Karl Fischer coulometric titration. In some embodiments the amount of water in the reaction mixture is determined indirectly by measuring water content of an over-head distillate or condensate. In the present invention dry catalyst is employed which means that in one embodiment the catalyst contains less than about 100 ppm water, in another embodiment less than about 50 ppm water, and in another embodiment less than about 30 ppm water.

Following the achievement of a desired molecular weight the polymerization reaction may be quenched by addition of any known quenching agent. Suitable quenching agents typically comprise at least one acidic compound, said acidic compound being in solid, liquid, gaseous, or solution form. Suitable acids comprise organic acids, particularly carboxylic acids such as acetic acid, malic acid, oxalic acid, and the like. Suitable acids also comprise inorganic acids such as phosphorous acid, phosphoric acid, polyphosphoric acid, hypophosphorous acid, sulfuric acid, hydrochloric acid, preferably anhydrous hydrochloric acid, and the like. A gaseous acid, such as anhydrous hydrochloric acid, can be bubbled into the mixture through a sparger or delivered as a solution in a convenient solvent such as the same organic solvent as used in the mixture. Mixtures comprising at least two acids may also be employed.

The amount of quenching agent used is an amount sufficient to end the polymerization reaction. In particular embodiments the amount of acid quenching agent used is at least sufficient to react with the calculated amount of phenoxide end-groups that will be present for a given molecular weight of polyethersulfone product. Preferably the quantity of acid added is greater than the calculated amount and more preferably about twice the calculated amount of phenoxide end-groups that will be present for a given molecular weight of polyethersulfone product. The acid may be added using any convenient protocol. In some embodiments the amount of acid added is in a range of between about 0.02 to about 0.21 millimoles (mmol) acid per gram of polymer or between about 0.07 to about 0.21 mmol acid per gram of polymer.

The polyethersulfones may be isolated by conventional methods. These may include, but are not limited to, one or more steps of salt agglomeration; filtration, washing with water, solvent removal, precipitation, drying and the like. In some embodiments a reaction mixture comprising polyethersulfone is combined with a non-solvent for the polyethersulfone to effect precipitation of the polymer. In another embodiment the polymer can be isolated by steps which comprise total devolatilization, for example in a devolatilizing extruder.

The polyethersulfones of the invention are further characterized by a glass transition temperature (Tg), greater than at least about 190° C. in one embodiment, greater than at least about 205° C. in another embodiment, and greater than at least about 210° C. in still another embodiment.

In one embodiment polyethersulfones of the present invention have a notched Izod impact strength value of at least about 470 Joules per meter (Jm-⁻¹) as determined using ASTM D256. In an alternate embodiment polyethersulfones of the present invention have a notched Izod impact strength value in the range of between about 470 Jm⁻¹ and about 825 Jm⁻¹.

Melt viscosities of polyethersulfones of the invention may be measured as zero shear melt viscosities at 340° C. In one embodiment the polyethersulfones of the invention possess a melt viscosity of less than about 4,500 pascal.seconds (Pa.s). In another embodiment the melt viscosity is less than about 4,000 Pa.s. In yet another embodiment the melt viscosity is in a range between about 1,000 and about 3,000 Pa.s, or in a range between about 1,500 and about 3,000 Pa.s.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner. In the following examples values for glass transition temperatures (Tg) were determined by differential scanning calorimetry (DSC) at a heating rate of 20° C. per minute. Weight average molecular weights were measured by gel permeation chromatography (GPC) versus polystyrene standards using as solvent a mixture of chloroform with 3.5 vol. % isopropanol. The GPC column was a Mixed-C column with dimensions 300 millimeters (mm)×7.5 mm available from Polymer Laboratories.

POLYMERIZATION PROCEDURE: A slurry of the disodium salt of bisphenol-A (5.271 grams, 19.361 millimoles) and the disodium salt of biphenol 17.9172 grams, 77.842 millimoles) was made in dry o-dichlorobenzene (131 grams), with less than about 20 parts per million (ppm) water content in a 250 milliliter three-neck round-bottom flask equipped with short-path distillation head, mechanical stirring and gas inlet in an inert atmosphere of nitrogen or argon. A portion of o-dichlorobenzene (about 45 grams) was then distilled off at a temperature of about around 200-220° C. The distillation was carried out until the water concentration of the distillate was below about 15 ppm. Dichlorodiphenylsulfone (27.9137 grams, 97.204 millimoles) and o-dichlorobenzene (52.7 grams) were added to the reaction mixture. A portion of o-dichlorobenzene (about 45 grams) was distilled out until the water concentration of the distillate was below about 15 ppm. A solution of hexaethylguanidinium chloride (0.79 molar) in dry o-dichlorobenzene (5.0 milliliters, 3.95 millimoles) was added to the reaction mixture over a time period of about two minutes. Polymerization occurred as a slightly exothermic reaction. Periodically samples were taken to monitor molecular weight of the polymer. When the target molecular weight was reached, the reaction was quenched with 85 % phosphoric acid (80 to 150 milligrams) at 180° C. with stirring and then the mixture was diluted with o-dichlorobenzene (265 milliliter; 346 grams) to about 10% solids.

The polymer obtained by the above process was then purified and isolated. Sodium chloride formed as by-product was removed by agglomeration and filtration. Agglomeration of the NaCl was achieved at 90° C. by addition of 0.3 weight % water (based on wt. o-dichlorobenzene+wt. polymer) with vigorous stirring, and the residual water was boiled off at 150° C. The mixture was cooled to 90° C. followed by filtration using filter of variable pore size, typically between 2-10 microns under a pressure of about 0.138 megapascals. The filtration was performed as many times as necessary to remove the sodium chloride to a level of less than about 5 ppm as measured by sodium ion specific probe (typically one filtration is enough). The catalyst was removed by water wash (1:2 weight ratio of water to organic phase) at 90° C. under stirring for a time sufficient to obtain a homogenous emulsion ensuring good interaction of the water with the organic layer. The organic phase was separated from the aqueous phase and the process was repeated as necessary until the amount of the catalyst was less than about 250 ppm with respect to the polymer as measured ion chromatography. In an alternative procedure catalyst may be removed by anti-solvent precipitation into methanol. Again, the process may be repeated as necessary until the amount of the catalyst is less than about 250 ppm with respect to the polymer as measured ion chromatography. In another alternative procedure, the catalyst may be removed by adsorption using silica gel.

Isolation of the polymer itself was carried out by an anti-solvent precipitation into methanol using a ratio of 1:4 organic solution:methanol by volume. The polymer was isolated, for example, by filtration and then redissolved in chloroform in 10% solids followed by a second anti-solvent precipitation into methanol (1:4 organic solution:methanol by volume), filtration and drying at elevated temperature under vacuum. Alternatively, the polymer may be isolated by devolatilization of solvent using a vacuum-vented extruder.

Characterization data for polyethersulfones which are examples of the invention or which are comparative examples are shown in Table 1. In Table 1 the abbreviations are defined as follows: CEx.=Comparative Example which falls outside the scope of the invention; A=bisphenol-A; B=biphenol; US=unstabilized composition; S=composition stabilized by addition of 1300 ppm IRGANOX 1010 and 2600 ppm IRGAFOS 168 commercial stabilizers. Comparative Example 1 was a commercial polyethersulfone available from Solvay Advanced Polymers under the tradename UDEL. Comparative Example 2 was a commercial polyethersulfone available from Solvay Advanced Polymers under the tradename RADEL. The data in Table 1 show that the polyethersulfones of the invention possess surprisingly better properties than commercial polyethersulfones.

TABLE 1

| | Ex. 1 | Ex. 2 | Ex. 3 | CEx. 1 | CEx. 2 | CEx. 3 | CEx. 4 | CEx. 5 | CEx. 6 | CEx. 7 |
|---|---|---|---|---|---|---|---|---|---|---|
| Formulation | 30% A + | 30% A + | 20% A + | 100% A | 100% B | 30% A + | 40% A + | 40% A + | 35% A + | 40% A + |
| (mole %) | 70% B | 70% B | 80% B | | | 70% B | 60% B | 60% B | 65% B | 60% B |
| | | (S) | | | | | (US) | (S) | (S) | |
| Molecular | 55200 | 60000 | 57700 | 62000 | 45000 | 52500 | 55000 | 55400 | 59800 | 54000 |
| weight (M_{w}) | | | | | | | | | | |
| T_{g} (° C.) | 212 | 213 | 216 | 190 | 224 | 208 | 209 | 209 | 211 | 209 |
| Zero Shear | 3520 | 5700 | 5100 | 1770 | 4480 | 3480 | 3150 | 3600 | 5000 | 3350 |
| Viscosity at | | | | | | | | | | |
| 340° C. (Pa · sec) | | | | | | | | | | |
| Notched Izod | 803 | 823 | 803 | 35 | 700 | 165 | 112 | 106 | 176 and | 130 |
| (Jm⁻¹) | | | | | | | | | 800* | |

*exhibited two ranges of impact strength values indicating that the test specimens were at the ductile-brittle transition point for this particular composition

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A polyethersulfone composition comprising structural units derived from a monomer mixture comprising bisphenol-A and at least 55 mole percent of 4,4′-biphenol based on total moles of diphenolic monomers, wherein the polyethersulfone has a minimum weight average molecular weight (M_{w}) defined by the relationship
M_{w}=((−750)×mole percent structural units from biphenol monomer)+105,000;
and wherein said polyethersulfone has a notched Izod impact strength value of greater than 470 Joules per meter as measured by ASTM D256.

2. The composition according to claim 1, wherein the polyethersulfone comprises structural units derived from 60-98 mole percent of the biphenol based on total moles of diphenolic monomers.

3. The composition according to claim 1, wherein the polyethersulfone comprises structural units derived from 65-85 mole percent of the biphenol based on total moles of diphenolic monomers.

4. The composition according to claim 1, wherein the polyethersulfone further comprises structural units derived from 5 mole % or less of at least one additional diphenolic monomer, based on total moles of diphenolic monomers.

5. The composition according to claim 4, wherein the additional diphenolic monomer is at least one member selected from the group consisting of a substituted derivative of 4,4′-biphenol and those monomers of the formula 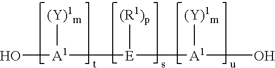
wherein A¹ represents an aromatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹ independently at each occurrence comprises a mono-valent hydrocarbon group, alkenyl, allyl, alkyl, aryl, aralkyl, alkaryl, or cycloalkyl;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on A¹ available for substitution;
the letter “p” represents an integer from and including zero through the number of replaceable hydrogens on E available for substitution;

6. The composition according to claim 4, wherein the additional diphenolic monomer is at least one member selected from the group consisting of those monomers of the formulas 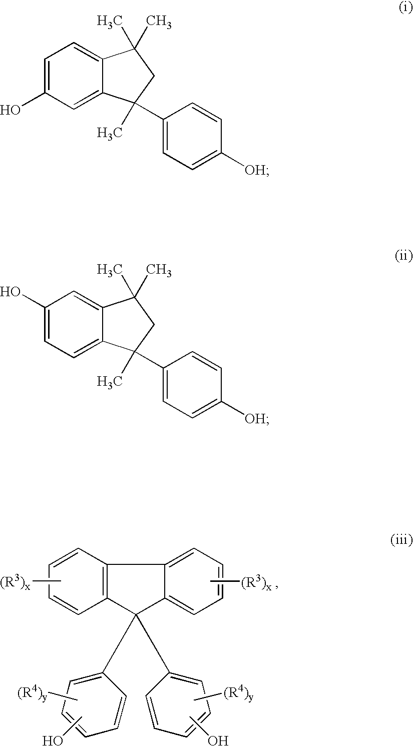
wherein each R³and R⁴ is independently selected from monovalent alkyl, aryl and halogen radicals; and the values for the parameters x and y are each independently selected from positive integers having a value of from 0 to 3 inclusive; 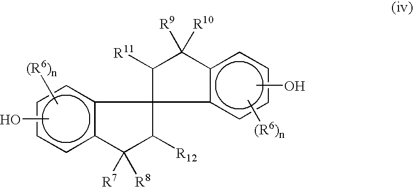
wherein each R⁶ is independently selected from monovalent alkyl, aryl and halogen radicals; each R⁷, R⁸, R⁹, and R¹⁰ is independently C₁₋₆ alkyl; each R¹¹ and R¹² is independently H or C₁₋₆ alkyl; and each n is independently selected from positive integers having a value of from 0 to 3 inclusive; and 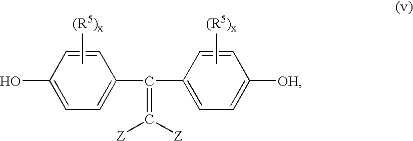
wherein each R⁵ is independently at each occurrence hydrogen, chlorine, bromine, alkyl or a C₁-C₃₀ monovalent hydrocarbon or hydrocarbonoxy group, and each Z is hydrogen, chlorine or bromine, subject to the provision that at least one Z is chlorine or bromine, and the value for the parameter x is independently at each occurrence selected from positive integers having a value of from 0 to 3 inclusive.

7. The composition according to claim 6, wherein the additional diphenolic monomer is at least one member selected from the group consisting of 9,9-bis(4-hydroxyphenyl) fluorene and 2,2,2′,2′-tetrahydro-3,3,3′,3′-tetramethyl-1,1′-spirobi[1H-indene]-6,6′-diol.

8. The composition according to claim 1, wherein the polyethersulfone has a minimum weight average molecular weight in a range of between about 30,000 and about 66,000.

9. The composition according to claim 1, wherein the polyethersulfone has a minimum weight average molecular weight in a range of between about 32,000 and about 64,000.

10. The composition according to claim 1, wherein the polyethersulfone has a minimum weight average molecular weight in a range of between about 34,000 and about 60,000.

11. The composition according to claim 1, wherein the glass transition temperature is in the range between about 190° C. and about 225° C.

12. The composition according to claim 1, wherein the glass transition temperature is greater than about 205° C.

13. The composition according to claim 1, wherein the polyethersulfone has a melt viscosity of less than about 4,500 pascal-seconds as measured at 340° C.

14. The composition according to claim 1, wherein the polyethersulfone has a melt viscosity in a range of between about 1,500 pascal-seconds and about 3,000 pascal-seconds as measured at 340° C.

15. The composition according to claim 1, wherein the polyethersulfone further comprises structural units derived from at least one chain terminating agent.

16. The composition according to claim 15, wherein the chain terminating agent is at least one member selected from the group consisting of chloro-N-arylphthalimides, chloro-N-alkylphthalimides, alkyl halides, alkyl chlorides, aryl halides and aryl chlorides of formula: 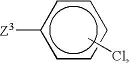
wherein the chlorine substituent is in the 3- or 4-position, and Z³ comprises a substituted or unsubstituted alkyl or aryl group.

17. The composition according to claim 16, wherein the chain terminating agent is at least one member selected from the group consisting of 4-chlorodiphenylsulfone, 3-chloro-N-phenylphthalimide, 3-chloro-N-methylphthalimide, 4-chloro-N-phenylphthalimide and 4-chloro-N-methylphthalimide.

18. A polyethersulfone composition comprising structural units derived from 4,4′-biphenol and bisphenol-A in a molar ratio of about 60:40 and having a weight average molecular weight of at least about 60,000;
or having structural units derived from 4,4′-biphenol and bisphenol-A in a molar ratio of about 70:30 and having a weight average molecular weight of at least about 52,000; or
having structural units derived from 4,4′-biphenol and bisphenol-A in a molar ratio of about 80:20 having a weight average molecular weight of at least about 45,000,
wherein said polyethersulfone has a notched Izod impact strength value of greater than 470 Joules per meter as measured by ASTM D256 and a melt viscosity of less than about 4,500 pascal-seconds as measured at 340° C.

19. An article comprising the composition of claim 1.

20. An article comprising the composition of claim 18.

21. A method for the synthesis of a polyethersulfone comprising structural units derived from a monomer mixture comprising bisphenol-A and at least 55 mole percent of 4,4′-biphenol based on total moles of diphenolic monomers, wherein the said polyethersulfone has a minimum weight average molecular weight (M_{w}) defined by the relationship
M_{w}=((−750)×mole percent structural units from biphenol monomer)+105,000;
and wherein the said polyethersulfone has a notched Izod impact strength value of greater than 470 Joules per meter;
wherein said method comprises the steps of:
a. contacting dialkali metal salts of said bisphenol-A and 4,4′-biphenol in a substantially dry solvent with at least one dihalodiarylsulfone in the presence of a phase transfer catalyst; and
b. quenching the reaction with an acidic quencher.

22. The method according to claim 21 wherein the solvent is at least one member selected from the group consisting of ortho-dichlorobenzene, dichlorotoluene, 1,2,4-trichlorobenzene, diphenyl sulfone, phenetole, anisole and veratrole.

23. The method according to claim 22 wherein the solvent is ortho-dichlorobenzene.

24. The method according to claim 21 wherein the salts are disodium salts.

25. The method according to claim 21 wherein the phase transfer catalyst is hexaethylguanidinium chloride.

26. The method according to claim 21 wherein the dihalodiarylsulfone is 4,4′-dichlorodiphenylsulfone.

27. The method according to claim 21 further comprising the step of isolating said polyethersulfone.

28. The method according to claim 21, wherein the polyethersulfone has a melt viscosity of less than about 4,500 pascal-seconds as measured at 340° C.

29. A method for the synthesis of a polyethersulfone comprising structural units derived from a monomer mixture comprising bisphenol-A and at least 55 mole percent of 4,4′-biphenol based on total moles of diphenolic monomers, wherein the polyethersulfone has a minimum weight average molecular weight (M_{w}) defined by the relationship
M_{w}=((−750)×mole percent structural units from biphenol monomer)+105,000;
and wherein the polyethersulfone has a notched Izod impact strength value of greater than 470 Joules per meter; and wherein the polyethersulfone has a melt viscosity of less than about 4,500 pascal-seconds as measured at 340° C.;
wherein said method comprises the steps of:
a. contacting dialkali metal salts of said bisphenol-A and 4,4′-biphenol in a substantially dry solvent with 4,4′-dichlorodiphenylsulfone in the presence of hexaethylguanidinium chloride as a phase transfer catalyst; and
b. quenching the reaction with an acidic quencher.

30. The method according to claim 29 further comprising the step of isolating said polyethersulfone.
